(19) United States
(12) Patent Application Publication
(10) Pub. No.: US 2025/0387775 A1
(43) Pub. Date: Dec. 25, 2025

(54) COMPOSITIONS FOR CO2 SEPARATION FROM HIGH TEMPERATURE EFFLUENTS

(71) Applicant: Valero Services, Inc., San Antonio, TX (US)

(72) Inventors: Michael J. Rubal, Lytle, TX (US); Michael A. Miller, Helotes, TX (US)

(21) Appl. No.: 19/244,763

(22) Filed: Jun. 20, 2025

Related U.S. Application Data
(60) Provisional application No. 63/662,908, filed on Jun. 21, 2024.

(51) Int. Cl. B01J 20/04; B01D 53/14; B01J 20/22

(52) U.S. Cl. CPC B01J 20/041; B01D 53/1475; B01J 20/22; B01D 2252/10; B01D 2257/504; B01J 2220/46; B01J 2220/4806

(57) ABSTRACT

The present disclosure provides improved compositions and methods for creating robust lithium zirconate-based solid-state compositions with enhanced mechanical properties and CO₂ separation performance. These compositions address the longstanding challenges of poor cohesion, dimensional instability, and durability that have limited the practical implementation of lithium zirconate in industrial CO₂ separation processes. By enabling the practical use of high-temperature CO₂ separation compositions, the present disclosure contributes to the technical field of carbon capture and climate change mitigation.

### CROSS-REFERENCE TO RELATED APPLICATIONS

This application claims priority to U.S. Provisional Patent Application No. 63/662,908, filed Jun. 21, 2024, the content of which is incorporated herein by reference in its entirety.

### FIELD

The present disclosure relates to improved compositions and manufacturing processes for the synthesis of high selectivity solid-state compositions based on lithium zirconate with robust physical properties for the separation of carbon dioxide from gas mixtures in high temperature effluents.

### BACKGROUND

Lithium zirconate, referred to herein as LZO, is a ceramic material that has been investigated for its potential use for the separation of carbon dioxide (CO₂) from gas mixtures, such as in carbon capture and storage and hydrogen production. Although often presented as the chemical formula Li₂ZrO₃, LZO can exist with different chemical formulas than Li₂ZrO₃, also known as lithium metazirconate. The exact chemical formula may vary depending on the ratio of lithium to zirconium.

LZO has shown promise as a solid-state sorbent for CO₂ separation via capture and regeneration due to its high selectivity for CO₂. This selectivity arises from a chemisorption equilibrium reaction between CO₂ and LZO, yielding lithium carbonate (Li₂CO₃) and zirconium oxide (ZrO₂) through a mechanism whereby CO₂ is incorporated into the crystal lattice of LZO, whereas other gas species are much less readily absorbed via physisorption.

Unlike conventional gas separation techniques such as those based on liquid amines for CO₂ absorption, LZO is a solid-state sorbent that is active at high temperatures, making it suitable for industrial processes that emit hot CO₂-bearing waste effluents, including flue gases produced by the combustion of fossil fuels. Being a thermally activated absorption mechanism allows for the regeneration of the sorbent and release of CO₂ at elevated temperature. By separating CO₂ from other gases, it can be captured, stored, or utilized to reduce greenhouse gas emissions.

Despite its potential advantages, there are material challenges associated with the practical implementation of LZO CO₂ separation into industrial processes. These challenges include the manufacturability of mechanically robust compositions, long-term stability and durability of the material, resistance to impurities, and the cost of manufacturing and maintaining such compositions. LZO is a mixed metal oxide powder like other ceramic materials, and while solid bodies can be formed when it is compressed under high pressure, it remains friable like chalk. In the context of material properties, the poor cohesion and fracture toughness of pure LZO solid-state compositions, along with volumetric dimensional changes that occur during CO₂ sorption and thermal cycling, are significant impediments to enabling the manufacture and practical use of this material for high temperature capture and regeneration. As such, the development of advanced material formulations is crucial for the successful implementation of LZO-based solid-state compositions in CO₂ separation processes.

Therefore, there exists a need for advanced material formulations and manufacturing methods for producing mechanically robust LZO-based solid-state compositions while maintaining or enhancing CO₂ absorption performance for practical applications in high-temperature CO₂ separation processes.

### BRIEF SUMMARY

Accordingly, the present disclosure addresses this need by providing compositions and methods for creating robust lithium zirconate (LZO) based solid-state compositions for high-temperature CO₂ separation applications.

In some instances, the disclosure provides compositions in which LZO powder is blended with ceramic binders (e.g., alumina oxide, silicon dioxide, zirconium oxide, among others), enabling the creation of durable solid bodies through compression molding and heat treatment.

In other instances, micro-aggregate compositions formed by combining LZO with polyhedral oligomeric silsesquioxane (POSS) compounds are described, creating a dense, cohered microstructure that substantially increases strength and fracture toughness while inhibiting dimensional changes during CO₂ sorption and thermal cycling.

In further instances, formulations where lithium and potassium carbonates are combined with zirconium oxide and optionally blended with ceramic binders such as Bisque Fix (BF) are detailed, which form moldable pastes that can be shaped into various geometries and calcinated to produce robust solid-state forms with improved cohesion.

The compositions and methods described herein provide improved LZO-based materials that maintain CO₂ absorption/desorption functionality while exhibiting significantly enhanced mechanical properties compared to pure LZO, making them suitable for practical implementation in industrial CO₂ capture processes. Such industrial capture processes may incorporate use of the solid LZO compositions such as solid-state membranes or sorbents in fixed or fluidized bed systems.

The compositions and methods described herein provide improved mechanical properties and enhanced CO₂ separation performance. Both the ceramic binder and POSS micro-aggregate approaches yield compositions with superior cohesion, fracture toughness, and dimensional stability, while simultaneously achieving CO₂ absorption rate constants up to 6 times higher than pure LZO. This combination of structural integrity and functional performance enables practical implementation in demanding industrial applications where conventional materials would rapidly deteriorate. The compositions can be tailored through component ratios and preparation methods, and formed into various geometries including disks, tubes, and annular structures to suit specific implementation requirements. These advantages are particularly valuable for a range of applications, including high-temperature carbon capture in cement, steel, and power generation facilities; CO₂/H₂ separation in hydrogen production; CO₂ removal from natural gas streams; and various industrial gas purification processes. Further performance enhancements through copper addition and regeneration in air demonstrate the adaptability of these materials to meet the specific challenges of different separation environments, offering a versatile solution to the longstanding challenge of implementing effective, durable CO₂ separation technologies in high-temperature industrial settings.

In one aspect, provided herein is a composition for carbon dioxide separation comprising lithium zirconate and a binder material, wherein the composition forms a solid body capable of selectively separating carbon dioxide from gas mixtures at high temperatures.

In some embodiments, the lithium zirconate is prepared by reacting lithium carbonate with zirconium oxide.

In some embodiments, the binder material comprises at least one ceramic filler material.

In some embodiments, the binder material comprises at least one component selected from the group consisting of aluminum oxide (Al₂O₃), aluminum nitride (AlN), aluminum oxide-quartz (Al₂O₃—SiO₂), magnesium oxide (MgO), silicon dioxide (SiO₂), zirconium oxide-zirconium ortho silicate (ZrO₂—ZrSiO₄), zirconium oxide (ZrO₂), and silicon carbide (SiC).

In some embodiments, the lithium zirconate has a chemical formula of Li₍₂₊ₓ₎Zr_{(1-z)} O₃, wherein 0≤x≤0.5 and 0.01≤z≤0.1.

In some embodiments, the composition further comprises potassium to form a eutectic composition which has a chemical formula of Li₍₂₊ₓ₎KyZr_{(1-z)}O3, wherein 0≤x≤ 0.5 and 0.15≤y≤0.25 and 0.01≤z≤0.1.

In some embodiments, the solid body has a carbon dioxide absorption rate constant that is at least 2 times higher than that of pure lithium zirconate at a temperature between 600° C. and 700° C.

In some embodiments, the composition further comprises a polyhedral oligomeric silsesquioxane (POSS) component forming a micro-aggregate structure with the lithium zirconate. In some further embodiments, the POSS component comprises octamethyl-POSS or octaphenyl-POSS. In some further embodiments, the lithium zirconate and POSS are combined at a weight ratio of 1.5:1 to 12:1.

In some embodiments, the composition further comprises a chemical additive selected from the group consisting of tetraethoxysilane (TEOS), colloidal silica, and ethanol.

In another aspect, provided herein is a solid-state lithium zirconate composition for carbon dioxide separation from a gas mixture, the composition comprising: a solid body formed from lithium zirconate and a ceramic binder material or a lithium zirconate-POSS micro-aggregate; wherein the composition exhibits a carbon dioxide absorption rate constant greater than 0.05 min⁻¹ at a temperature between 600° C. and 700° C.; and wherein the composition maintains structural integrity during carbon dioxide absorption and desorption cycles.

In some embodiments, the lithium zirconate comprises potassium-modified lithium zirconate having a molar ratio of lithium to potassium to zirconium of 2.0 to 2.5:0.15 to 0.25:0.9 to 0.99.

In some embodiments, the composition is configured to withstand volumetric dimensional changes during carbon dioxide sorption and thermal cycling without substantial mechanical degradation.

In yet another aspect, provided herein is a composition for separating carbon dioxide gas, comprising: a lithium zirconate and a polyhedral oligomeric silsesquioxane (POSS), wherein the POSS is present in a weight ratio between 0.07 and 1 to the lithium zirconate, wherein the POSS is octamethyl silsesquioxane or octaphenyl silsesquioxane.

In some embodiments, the octamethyl silsesquioxane is present in a weight ratio between 0.125 and 0.25 to the lithium zirconate, or wherein the octaphenyl silsesquioxane is present in a weight ratio between 0.33 and 1 to the lithium zirconate.

In still another aspect, provided herein is a composition for separating carbon dioxide gas, the composition comprising: zirconium oxide, lithium carbonate, potassium carbonate, and a binder, wherein: the lithium carbonate is present in a molar ratio between 2 and 3 to the zirconium oxide, the potassium carbonate is present in a molar ratio between 0.1 and 1 to the zirconium oxide, and the binder is present in a weight ratio between 1 and 50% to the zirconium oxide.

In still another aspect, provided herein is a composition for separating carbon dioxide gas, the composition comprising: lithium zirconate, potassium carbonate, and a binder, wherein: the potassium carbonate is present in a molar ratio between 0.1 and 1 to the lithium zirconate, and the binder is present in a weight ratio between 1 and 50% to the lithium zirconate, wherein the binder comprises Bisque Fix and sodium silicate.

In some embodiments of the foregoing, a carbon dioxide absorption rate constant of the composition is between 5.00×10⁻² min⁻¹ and 6.00×10⁻² min⁻¹ at 600° C. or between 5.00×10⁻² min⁻¹ and 6.00×10⁻² min⁻¹ at 700° C.

In some embodiments of the foregoing, a carbon dioxide desorption rate constant of the composition is between −2.00×10⁻² min⁻¹ and −3.00×10⁻² min⁻¹ at 600° C. or between-9.00×10⁻² min⁻¹ and −10.00×10⁻² min⁻¹ at 700° C.

The disclosure further provides a method of manufacturing a lithium zirconate-based micro-aggregate composition, the method comprising: combining lithium zirconate powder with a polyhedral oligomeric silsesquioxane (POSS) component; adding a thermally decomposable liquid binder to form a moldable mixture; forming the mixture into a desired shape; and sintering the formed mixture at a temperature between 600° C. and 900° C. to create a solid micro-aggregate composition.

In some embodiments, the POSS component comprises octamethyl-POSS or octaphenyl-POSS.

In some embodiments, the liquid binder comprises tetraethoxysilane (TEOS) or colloidal silica.

In some embodiments, forming the mixture into a desired shape comprises compression molding, pressing, or slip casting.

In some embodiments, the method further comprises compressing the formed mixture at a pressure ranging from 5,000 psi to 20,000 psi.

In some embodiments, the micro-aggregate composition exhibits enhanced mechanical strength, fracture toughness, and dimensional stability during carbon dioxide sorption and thermal cycling compared to pure lithium zirconate composition.

The disclosure further provides a method of separating carbon dioxide from a gas mixture, the method comprising: contacting the gas mixture with a solid-state composition comprising lithium zirconate and a ceramic binder material or a lithium zirconate-POSS micro-aggregate at a temperature between 600° C. and 700° C.; wherein the lithium zirconate reacts with carbon dioxide in the gas mixture to form lithium carbonate and zirconium oxide; and wherein the solid-state composition maintains structural integrity during carbon dioxide absorption and desorption cycles.

In some embodiments, the method further comprises regenerating the solid-state composition by heating to a temperature sufficient to release the absorbed carbon dioxide.

In some embodiments, the solid-state composition comprises a potassium-modified lithium zirconate that has an enhanced range of carbon dioxide absorption at lower temperatures compared to unmodified lithium zirconate.

In some embodiments, the composition comprises a dense, cohered structure with enhanced mechanical properties that inhibits dimensional changes during carbon dioxide sorption and thermal cycling.

In some embodiments, copper is incorporated into the solid-state composition to enhance carbon dioxide absorption.

The disclosure further provides a method of forming a lithium zirconate composition for separating carbon dioxide gas comprising: mixing a lithium zirconate and a polyhedral oligomeric silsesquioxane (POSS) at a ratio between 1 and 10 to form a homogeneous mixture; optionally adding a tetraethoxysilane in a weight ratio between 1 and 3 or a colloidal silica in a weight ratio between 1 and 6; pressing the homogeneous mixture at a first pressure between 44 MPa and 92 MPa; and drying the homogeneous mixture at a first temperature between 201° C. and 350° C. with a heating ramp rate of 1-5° C. per minute for at least two hours at less than a second pressure of 0.07 MPa to form the lithium zirconate composition.

In some embodiments, the method further comprises sintering the lithium zirconate composition at a second temperature between 601° C. and 900° C. with a heating ramp rate of 5-10° C. per minute for two hours.

In some embodiments, the POSS is octamethyl silsesquioxane or octaphenyl silsesquioxane, and the carbon dioxide absorption rate constant of the lithium zirconate composition is between 1.00×10⁻² min⁻¹ and 2.00×10⁻² min⁻¹ at 600° C. or between 4.50×10⁻³ min⁻¹ and 5.50×10⁻³ min⁻¹ at 700° C.

The disclosure further provides a method of separating carbon dioxide gas, comprising: flowing an effluent gas mixture through a composition, wherein the composition comprises components selected from the group consisting of: (a) a lithium zirconate and a polyhedral oligomeric silsesquioxane (POSS), wherein the POSS is present in a weight ratio between 0.07 and 1 to the lithium zirconate; and (b) a lithium zirconate, potassium (K), and a binder, wherein the potassium (K) is present in a molar ratio between 0.1 and 1 to the lithium zirconate, and the binder is present in a weight ratio between 1 and 50% to the lithium zirconate; absorbing the carbon dioxide gas into the composition at a temperature between 450° C. and 650° C., wherein the composition absorbs the carbon dioxide at an absorption rate constant between 1.00×10⁻² min⁻¹ and 1.00×10⁻¹ min⁻¹; and desorbing the carbon dioxide gas from the composition at a temperature above 651° C., wherein the composition desorbs the carbon dioxide at a desorption rate constant between −8.00×10⁻² min⁻¹ and −2.50×10⁻² min⁻¹.

In some embodiments, the POSS is octamethyl silsesquioxane or octaphenyl silsesquioxane.

### BRIEF DESCRIPTION OF THE DRAWINGS

The following drawings form part of the present specification and are included to further demonstrate certain aspects of the present disclosure, which can be better understood by reference to the drawing in combination with the detailed description of specific embodiments presented herein.

FIG. 1 shows a sintered disk composed of LZO/OM-POSS (6:1 by weight) using TEOS binder.

FIG. 2 is an image comparing thermal cycling effects on LZO and LZO/POSS (micro-aggregate) sinters.

FIG. 3 shows Micro-CT transverse (top) and longitudinal (bottom) images scanned through the mid-section of an annulus structure.

FIG. 4 shows cross-sectional analysis of annulus and material microstructure under optical magnifications for LZO/OM-POSS micro-aggregate composition.

FIG. 5 is a SEM scan image of LZO/OM-POSS micro-aggregate material composition (500×) and corresponding EDS elemental maps of same image.

FIG. 6 shows a sintered disk composed of LZO/OM-POSS (3:2 by weight) using colloidal silica binder.

FIG. 7 is an exemplary thermal gravimetric analysis (TGA) plot of sol-gel LZO.

FIG. 8 shows examples of monolithic-shaped, calcinated LZO structures from compression molding.

FIG. 9 shows an example of an annulus design where LZO paste is compressed then calcinated between two porous tubes.

FIG. 10 shows MicroCT images of a calcinated, compression molded shaped Zr/carb+BF formulation.

FIG. 11 shows ESEM images of LZO material derived from calcinated ZrO₂/carbonate paste: (A) Low resolution image and (B) high resolution image of a cut away segment revealing the internal morphology of the sample.

FIG. 12 shows thermal gravimetric analysis of a ZrO₂/carb+BF calcinated puck.

FIG. 13 shows a tube form compaction die.

FIG. 14 shows a die pressed solid body prepared from LZO+Binder.

FIG. 15 shows a plot of absorption rate constants (Ka) versus temperature for various LZO formulations with ceramic binders.

FIG. 16 shows a plot of desorption rate constants (Kd) versus temperature for various LZO formulations with ceramic binders.

FIG. 17 shows a plot of absorption rate constants versus temperature of LZO materials from LZO/POSS formulations.

FIG. 18 shows a plot of desorption rate constants versus temperature of LZO materials from LZO/POSS formulations.

FIG. 19 shows a plot of absorption rate constants versus temperature for copper-infused LZO formulations and formulations tested in air.

FIG. 20 shows a plot of desorption rate constants versus temperature for copper-infused LZO formulations and formulations tested in air.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown but are to be accorded the scope consistent with the claims.

The present disclosure provides improved compositions and methods for forming mechanically robust solid bodies from lithium zirconate (LZO) while maintaining or enhancing carbon dioxide absorption capabilities. These solid bodies are particularly useful for the separation of carbon dioxide from gas mixtures at high temperatures. Surprisingly and unexpectedly, the disclosed compositions not only overcome the inherent mechanical limitations of pure LZO compositions, but also simultaneously enhance CO₂ absorption kinetics by up to 600% compared to conventional LZO formulations. This synergistic improvement in both mechanical properties and functional performance contradicts the expected trade-off between structural integrity and absorption capability typically observed in the art. Furthermore, the unique combination of specific molar ratios of lithium to zirconium (e.g., 2.0 to 2.5:0.9 to 0.99) with either ceramic binders containing select fillers or POSS components produces compositions that maintain dimensional stability during thermal cycling under conditions that cause pure LZO to rapidly deteriorate. Particularly surprising is the discovery that the incorporation of polyhedral oligomeric silsesquioxane (POSS) components forms micro-aggregate structures that not only reinforce the material but also create an interpenetrating network that facilitates CO₂ transport through the composition. Additionally, the unconventional approach of using slightly sub-stoichiometric zirconium content (e.g., 0.9 to 0.99 molar ratio) contributes to enhanced performance in a manner that contradicts conventional ceramic material design principles. These unexpected technical advantages enable practical implementation of LZO-based compositions in industrial carbon capture applications that were previously unattainable with conventional approaches.

### I. ZrO₂/Carbonate+BF Formulations

Lithium zirconate (LZO) can be prepared by combining zirconium oxide with lithium carbonate after calcination at elevated temperatures. The accepted mechanism associated with carbon dioxide (CO₂) absorption and desorption for LZO is shown in the following equilibrium reaction, representing LZO in the chemical formula of Li₂ZrO₃:

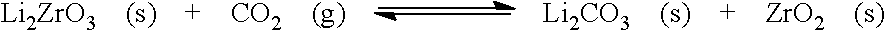

where the rate constant for CO₂ absorption by LZO is Ka and the rate constant for desorption from the zirconium oxide/carbonate form is Kd.

By considering the reverse reaction, LZO can be prepared by combining zirconium oxide with lithium carbonate after calcination at elevated temperatures. Additionally, potassium carbonate, as well as other carbonates, can also be included to promote eutectic mixtures with lower carbonate melting temperatures which can expand and enhance the lower range of CO₂ absorption/reaction of LZO to lower temperatures. The dry ZrO₂/carbonate formulation is shown in Table 1, where zirconium oxide (ZrO₂) powder, lithium carbonate (Li₂CO₃), and potassium carbonate (K₂CO₃) are combined to achieve the desired mol ratio of atoms with respect to zirconium. Mixing can be improved by the use of a mortar and pestle or other mechanical means.

TABLE 1
Formulation mol ratios with respect to zirconium.

| Atom | Ideal mol ratio | Range mol ratio |
|---|---|---|
| Zr | 1 | 1 |
| Li | 2.5 | 2 to 3 |
| K | 0.27 | 0 to 1 |

Although this solid mixture from Table 1 can be used to fabricate LZO material upon calcination, the output would be an unformed powder material unsuitable for direct use. Therefore, after the dry ZrO₂/carbonate formulation is prepared, deionized water (DI-water) is added to the dry formulation and mixed to form a ZrO₂/carbonate paste. The amount of DI-water can range from 0 to 30% (ideally 8 to 15%) volume of water to mass of dry formulation. The amount of water will depend on the consistency of the paste desired. This paste can be shaped by all methods known for those in the art of ceramic fabrication, compression molding, embossing, and film casting.

To improve cohesiveness of the final form, the addition of a ceramic material, such as the commercial product Bisque Fix (BF) from Amaco®, may also be mixed into the paste prior to shaping. BF is a white paste primarily composed of refractory ceramic fibers, water, amorphous silica, and smectite-group minerals, however other similar ceramic materials may also be used for the same or better effect. The BF addition can range from 0 to 50 wt % with respect to the paste ZrO₂/carbonate weight. After the formulation is completed and shaped into pre-calcinated forms, the sample is calcinated within a furnace by slowly ramping to 600° C. in air and holding isothermally at that temperature for 2 h before slowly cooling back to room temperature.

### II. LZO/POSS Micro-Aggregates

The poor cohesion and fracture toughness properties of pure LZO, along with volumetric dimensional changes that occur during CO₂ sorption and thermal cycling, are impediments to enabling the manufacture and practical use of CO₂-selective solid embodiments that are based upon this material chemistry for applications in high-temperature (e.g., ≥500° C.) CO₂ capture and regeneration. These undesirable material properties further compromise the durability and performance of produced embodiments, thus shortening composition life cycle and increasing cost of maintenance.

Addressing the need to overcome these impediments, aggregate compositions formed by combining LZO as a matrix component with cuboid (cage-like) organosilicon compounds, a class of hybrid materials known as polyhedral oligomeric silsesquioxane (POSS), are described. The dense, cohered aggregate microstructure thus formed after sintering increases substantially the strength and fracture toughness of the material, while also inhibiting dimensional changes that would otherwise readily occur in embodiments of LZO alone as a consequence of CO₂ sorption and thermal cycling.

These chemically bound aggregates can be formed by combining LZO powder with POSS of one or more particular types (solid powder or liquid), over a plurality of mass ratios depending on the organic ligands that are attached to the polyhedral structure of the POSS type and the mechanical properties desired of the aggregate. After thoroughly mixing the two components, a low molecular weight and thermally decomposable liquid binder is added to form a thin, lubricious paste with stirring. The tack and viscosity of the paste may be adjusted by allowing the mixture to dry under ambient conditions, producing a tailorable consistency suitable for slip casting and compressive molding into any form factor. The molded or cast form is then sintered into a solid embodiment.

The POSS type is defined by the ligands that are initially bound to the silicon vertices of the polyhedral silica structure (Structure I). Such types are numerous and can be readily obtained commercially (e.g., Hybrid Plastics, Inc., Hattiesburg, MS), the ligands (R) of which there are a plethora of possibilities, including, though not limited to, hydrogen, methyl, phenyl, isobutyl, silane, glycidyl, and trimethylamine.

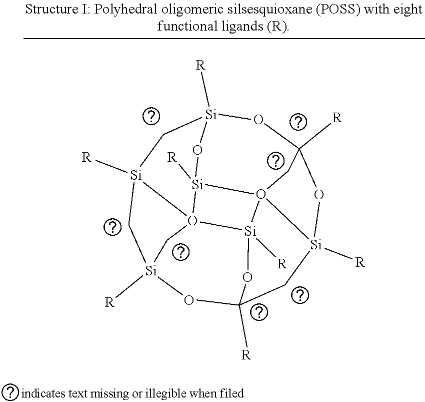

The choice of ligand and its complementary binder are crucial to the form and function of the composition and constitute inventive aspects of these embodiments. In particular, judicious selection of the ligand affords the polyhedral silica particles of a particular POSS type to be compatible physically and chemically with the LZO matrix, enabling the POSS type to be homogeneously dispersed in the paste-like mixture. Once dispersed in the matrix, the ligands are eliminated thermally during the sintering step, forming reactive centers on the remaining polyhedral silica particles that bridge chemically to nearby cuboids. These chemical bridges are essential to nucleating the growth of the aggregate components from molecular scales to micron scales. Concurrently, any excess binder in the matrix is thermally decomposed such that the organic components of the binder (where applicable) are eliminated from the matrix.

The net outcome is a strongly cohered embodiment with a microstructure that consists of microscale aggregate particles of cubic shapes dispersed in a matrix of LZO particles. The strength, fracture toughness, and volumetric behavior (i.e., mitigation of expansion and shrinkage) of the composition are substantially enhanced compared to LZO alone, even at the elevated activation temperatures that are required for chemisorption of CO₂ (e.g., 400-700° C., and more particularly 600-700° C.).

As will be shown in the examples, in addition to enhanced mechanical properties as described above, the sorption kinetics for the aggregate embodiments are also enhanced compared with LZO alone. A number of embodiments are described. Nevertheless, it will be understood that various modifications may be made. Accordingly, other embodiments are within the scope of the claims that follow the given examples.

### III. Solid Body-LZO+Ceramic Binder

Materials such as commercially available ceramic binders can be blended with LZO powder to induce better cohesion and reduce the friability of LZO. The binder can contain a range of ceramic fillers and inorganic binders. Prior to heat treatment, the LZO/binder mixture is dough-like and moldable and may be used in the creation of various form factors.

Once the LZO powder has been heat treated, a measured amount of ceramic based binder is added to the powder and mixed to form a paste. The binder is typically a liquid suspension that may contain a range of ceramic compounds, as listed in Table 2.

TABLE 2
Binder filler Material

| Name | Formula |
|---|---|
| Alumina Oxide | Al₂O₃ |
| Alumina Nitride | AlN |
| Alumina Oxide/Quartz | Al₂O₃—SiO₂ |
| Magnesium Oxide | MgO |
| Silicon Dioxide | SiO₂ |
| Zirconium Oxide/Zirconium Silicate | ZrO₂—ZrSiO₄ |
| Zirconium Oxide | ZrO₂ |
| Silicon Carbide | SiC |

The mixture can then be placed in a forming compaction die, such as a ring forming compaction die. Once filled and assembled, the die assembly is placed in a press and a pressure ranging from 5000 psi to 20,000 psi is applied.

The press formed piece is removed from the die and placed in a furnace for heat treatment. The solid piece is heat treated to 700 to 900° C. in a programmable oven under an atmosphere of air. The oven is set with a ramp rate of 10° C./min and held at final temperature for 0.5 to 3.0 hours. The material is allowed to cool in the oven. The piece is then removed from the oven for examination.

### IV. Rate Constant Assumptions and Calculations

The accepted mechanism associated with carbon dioxide (CO₂) absorption and desorption is shown in the equilibrium reaction above, where the rate constant for CO₂ absorption by LZO is Ka and the rate constant for desorption from the zirconium oxide/carbonate form is Kd. It should be noted that the LZO formulations may include other forms of carbonates such as potassium carbonate.

Formulations of LZO can vary considerably and contain inactive forms of carbonates and ZrO₂. The only thing that is relevant are active forms of LZO and active combination of Li₂CO₃ and ZrO₂. Therefore, the equilibrium reaction can be rewritten as:

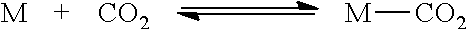

where:
M=mol fraction of active sites (LZO) that can absorb CO₂
M-CO₂=mol fraction of occupied sites (Li₂CO₃+ZrO₂) that can release CO₂

Finally, when the purge gas is 100% CO₂, one can eliminate the dependency on the CO₂ concentration (or at least contingent to the concentration and pressure CO₂ during the study), and, therefore, consider this process of absorption and desorption as a first order process with respect to mol fraction of active sites (LZO) for absorption and mol fraction of occupied sites (Li₂CO₃+ZrO₂) for desorption.

The rate equations are as follows:

$$Rate\_a = Ka [ M ] [ {CO}_{2} ] \\ Rate\_d = Kd [ M - {CO}_{2} ] \\ Rate\_total = Rate\_a - Rate\_d$$

For isothermal conditions in 100% CO₂ where [CO₂]=1:

$$Rate\_a = Rate\_total + Rate\_d$$

For isothermal conditions in N₂ where [CO₂]=0:

$$Rate\_d = Rate\_total + 0$$

From the TGA data, at time point t:

$$[ M ] t = [ ( mass\_min - mass\_t ) / 44.01 ] / [ ( mass\_max - mass\_min ) / 44.01 ] \\ [ M - {CO}_{2} ] t = [ ( mass\_t - mass\_min ) / 44.01 ] / [ ( mass\_max - mass\_min ) / 44.01 ]$$

During isotherm in N₂:

$$Kd = Rate\_total / [ M - {CO}_{2} ]$$

During isotherm in CO₂:

$$Rate\_a = Rate\_total + Kd [ M - {CO}_{2} ] \\ Ka = Rate\_a / [ M ] [ {CO}_{2} ] = Rate\_a / [ M ] ( in 100 \% {CO}_{2} )$$

### EXAMPLES

The following examples are offered to illustrate provided embodiments and are not intended to limit the scope of the present disclosure.

### Example 1: LZO/OM-POSS with TEOS Binder

Commercially obtained LZO powder (99.5%, D50<5.0 μm, Sigma-Aldrich®) was combined with octamethyl-POSS (Structure II) at a ratio of 6:1 by weight. The dry powders were thoroughly mixed for 15 min, after which time 1.87 parts by weight of tetraethoxysilane (TEOS, also known as tetraethyl orthosilicate) was added. The mixture was thoroughly stirred until a thin, paste-like consistency was formed.

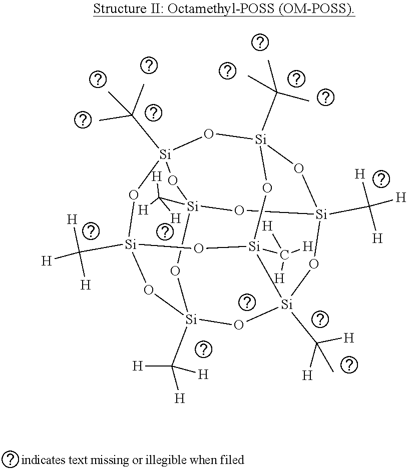 [SMILES: CC[Si]12O[Si]3(C)O[Si]4(C)O[Si](C)(O[Si]5(C(C)(C)C)O[Si](C(C)(C)C)(O4)O[Si](C)(O3)O[Si]1(C)O5)O2]

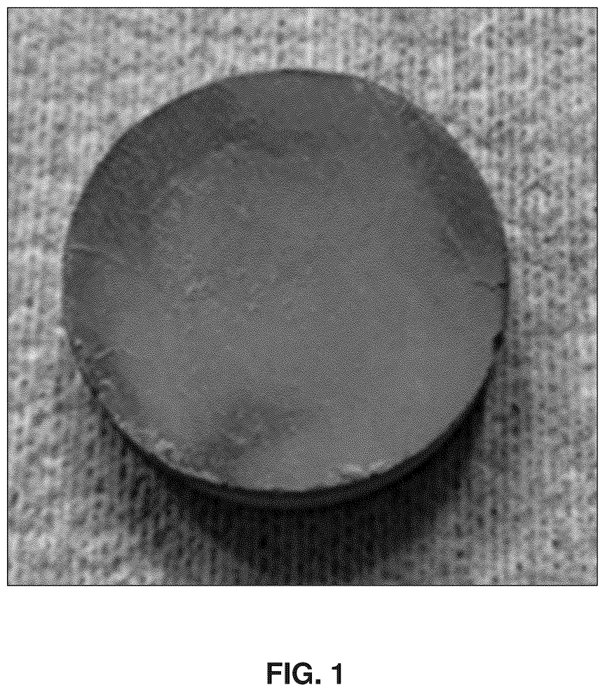

In a first embodiment, the homogeneous paste was transferred to a 25 mm diameter die and pressed to 44 MPa at room temperature to form a disk-shaped structure (25 mm diam.×˜3 mm). The disk was then initially cured in an oven for >2 hours at 200° C. under slight vacuum (˜0.07 MPa) using thermal ramp rate of 1° C./min. After cooling, the dried and semi-rigid disk was transferred to a high-temperature oven and sintered in air at 600° C. for 2 hours. Heating rate in this case was 5-10° C./min. After cool-down, a dense and rigid disk was formed as illustrated in FIG. 1.

Other ratios of LZO/OM-POSS may be used in forming dense, rigid disks with desirable properties; for example, disks at mass ratios of 12:1 and 1.5:1 have been made using the above-mentioned methods, each exhibiting similar favorable properties.

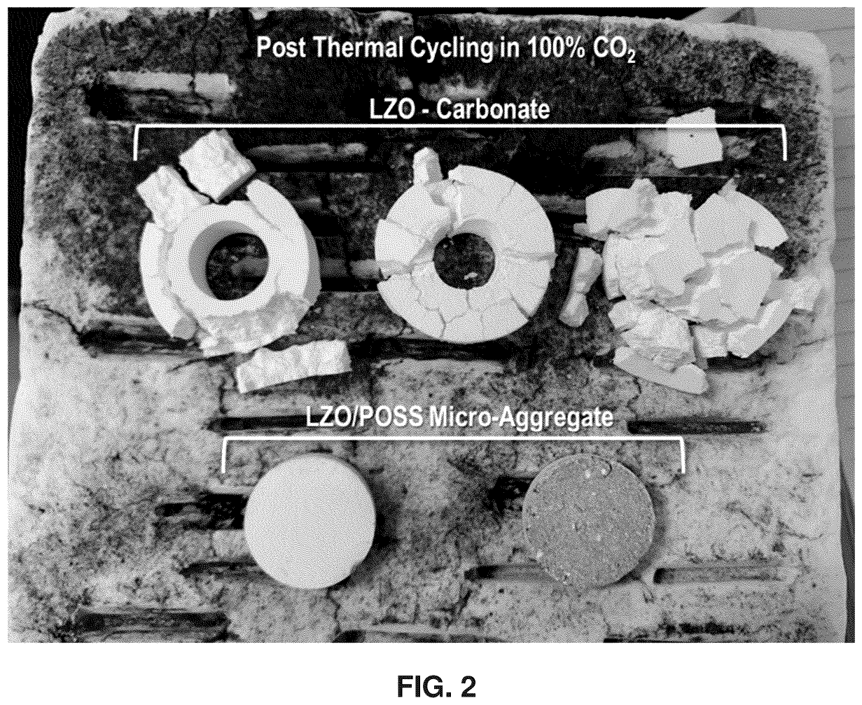

The physical durability of LZO/OM-POSS sintered compositions were assessed by subjecting them to thermal cycling under a pure gaseous CO₂ environment using a custom cyclic furnace. Thermal cycling conditions were: room temperate (RT)→650° C. at 5° C./min (hold 90 min)→near RT (hold 90 min) over nine cycles. As illustrated in FIG. 2, no measurable dimensional changes (shrinkage or expansion) or crumbling were observed for the LZO/OM-POSS micro-aggregate disks following the stated thermal cycling conditions.

In a second embodiment, the said LZO/OM-POSS paste formulation was pressed into the annulus space of a double-walled tubular structure (12.7 mm OD outer tube×6.35 mm OD inner tube×127 mm long), mimicking the form factor of cylindrical annulus membrane with ˜2 mm wall thickness. The pre-sintered paste was periodically compressed to ˜92 MPa until the annulus space was completely filled and compacted. The annulus structure was then subjected to the same initial cure and sintering conditions as described for the disk embodiment.

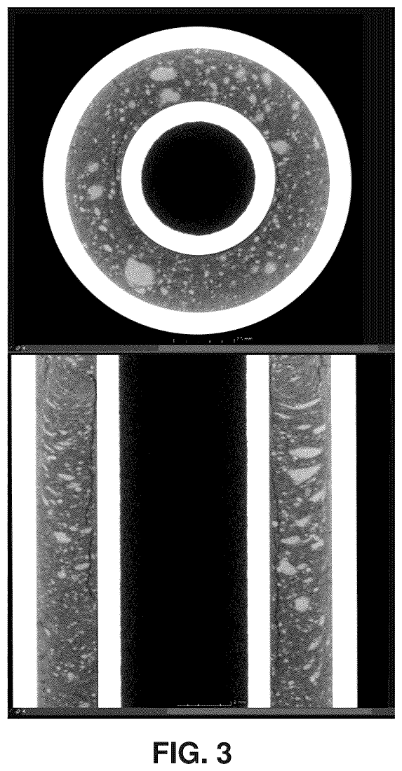

After cooling, the sintered annulus structure was imaged non-destructively by X-ray micro computed tomography (Micro-CT) to assess the internal structure and morphology of the material in the annulus space. Exemplar images scanned through longitudinal and transverse mid-sections of the annulus structure are shown in FIG. 3. These images show that the LZO/OM-POSS micro-aggregate composition is highly consolidated and does not exhibit any transverse cracking projecting through the wall thickness or any evidence that dimensional changes had occurred within the spatial resolution of the instrument (˜2 μm).

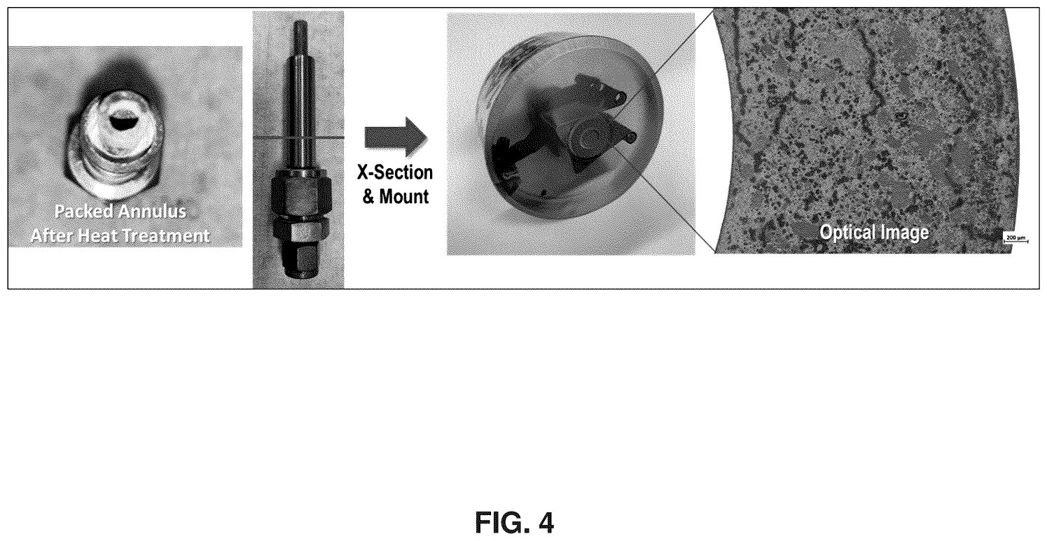

Additional analyses of the micro-aggregate LZO composition were conducted under high magnifications by cross-sectioning the annulus and cold mounting the cross-sectioned member in resin. After polishing the surface of the section, the structure and morphology of the composition were examined under optical and electron magnifications using a metallographic microscope and a scanning electron microscope (SEM), respectively. These steps are illustrated in FIG. 4, showing the microstructure of the material under optical magnifications.

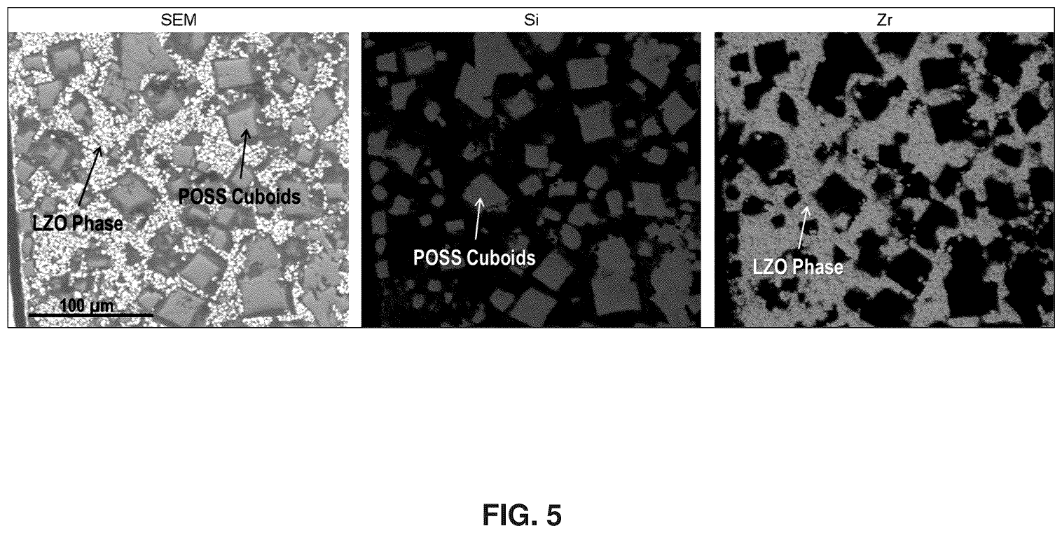

Additional insights into the microstructure of the LZO/OM-POSS micro-aggregate composition can be gleaned from SEM images and the corresponding elemental mapping of the scan image using energy dispersive X-ray spectroscopy (EDS), which are illustrated in FIG. 5. These analyses reveal clear boundaries between domains of POSS micro-aggregates and the surrounding LZO solid matrix. The LZO matrix is further shown to be conformal with the cubic micro-aggregates.

### Example 2: LZO/OP-POSS

Commercially obtained LZO powder (99.5%, D50<5.0 μm, Sigma-Aldrich®) was combined with octaphenyl-POSS (Structure III) at a ratio of 3:2 by weight. The dry powders were thoroughly mixed for 15 min. The homogeneous mixture was transferred to a 25 mm diameter die and pressed to 44 MPa at room temperature to form a disk-shaped structure (25 mm diam.×˜3 mm). The disk was then initially cured in an oven for ≥2 hours at 200° C. under slight vacuum (˜0.07 MPa) using thermal ramp rate of 1° C./min. After cooling down naturally, the dried and semi-rigid disk was transferred to a high-temperature oven and sintered in air at 600° C. for 2 hours.

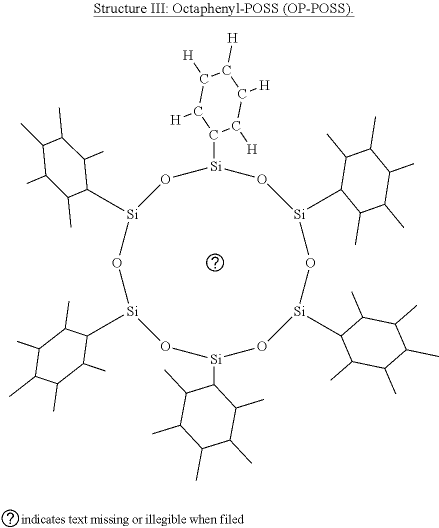

As in the previous example, the physical durability of LZO/OP-POSS sintered composition was assessed by subjecting it to thermal cycling under a pure gaseous CO₂ environment. After cycling (FIG. 2), no measurable dimensional changes (shrinkage or expansion) or crumbling were observed for the LZO/POSS micro-aggregate disk.

### Example 3: LZO/OM-POSS with Colloidal Silica Binder

Commercially obtained LZO powder (99.5%, D50<5.0 μm, Sigma-Aldrich®) was combined with octamethyl-POSS (Structure II) at a ratio of 3:2 by weight. The dry powders were thoroughly mixed for 15 min, after which time 4.16 parts by weight of colloidal silica (50%, Ludox®) was added. The viscosity of the mixture was reduced by adding ˜3 mL of ethanol, then thoroughly stirred until a thin, paste-like consistency was formed.

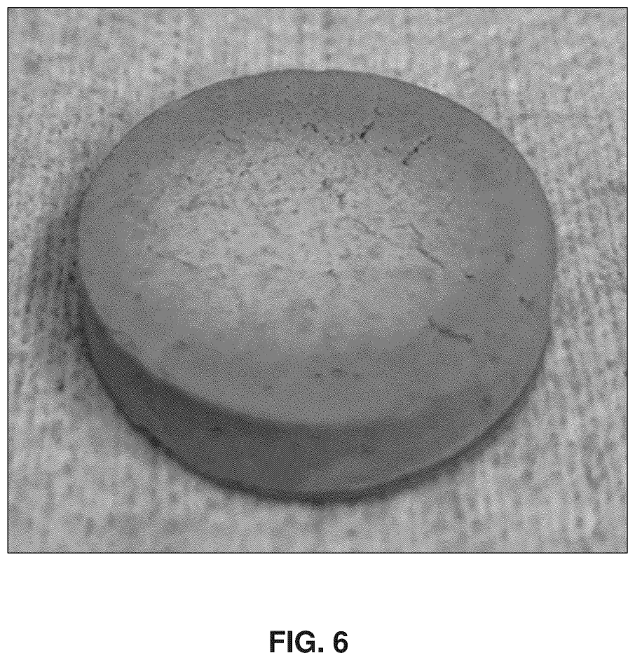

The homogeneous paste was transferred to a 25 mm diameter die and pressed to 44 MPa at room temperature to form a disk-shaped structure (25 mm diam.×˜3 mm). The disk was then initially cured in an oven for >2 hours at 200° C. under slight vacuum (˜0.07 MPa) using thermal ramp rate of 1° C./min. After cooling, the dried and semi-rigid disk was transferred to a high-temperature oven and sintered in air at 600° C. for 2 hours at a heating rate 5-10° C./min. After cool-down, a dense and very hard disk was formed as illustrated in FIG. 6.

### Example 4: ZrO₂/Carbonate+BF

The dry ZrO₂/carbonate formulation shown in Table 1 was prepared by combining zirconium oxide (ZrO₂) powder, lithium carbonate (Li₂CO₃), and potassium carbonate (K₂CO₃) to achieve the desired mol ratio of atoms with respect to zirconium. After the dry ZrO₂/carbonate formulation was prepared deionized water (DI-water) was added to the dry formulation and mixed to form a ZrO₂/carbonate paste. The amount of DI-water was 10% volume of water to mass of dry formulation.

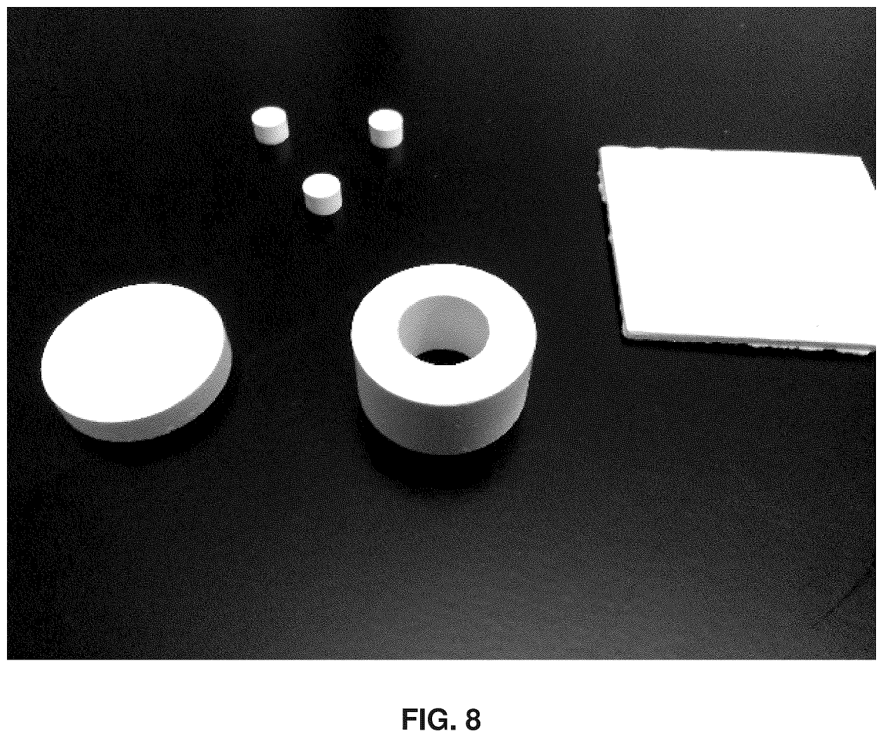

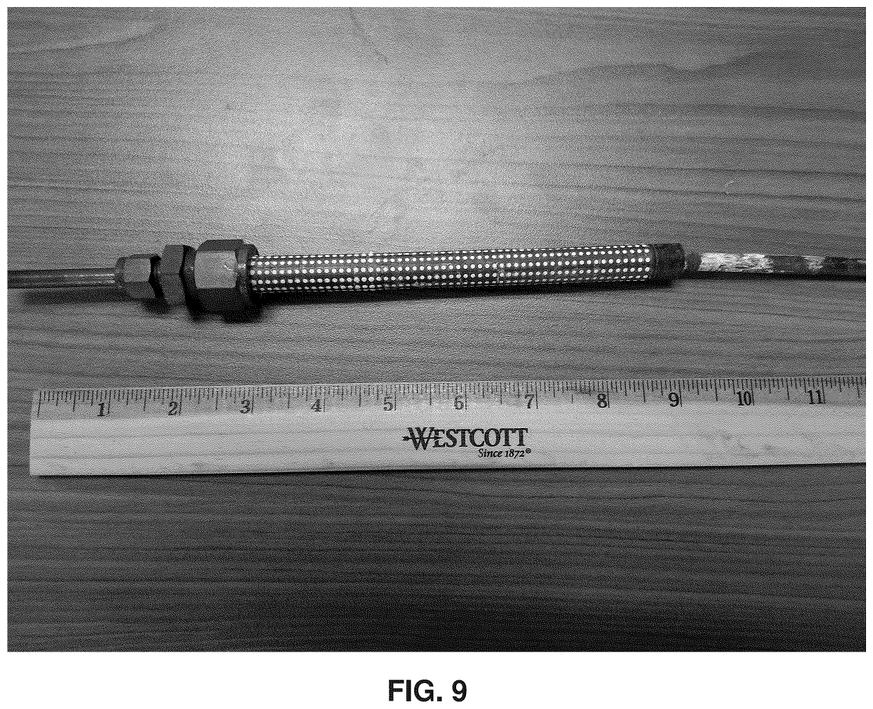

The commercial product Bisque Fix (BF) from Amaco® was also mixed into the paste at 15 wt % with respect to paste ZrO₂/carbonate weight. After the formulation was completed, the paste was used to create monolithic samples shown in FIG. 8 and an annulus device shown in FIG. 9.

After shaping, the samples were calcinated within a furnace by slowly ramping to 600° C. in air and holding isothermally at that temperature for 2 h before slowly cooling back to room temperature. Samples retained their shape and activity (absorption desorption capacity for CO₂) during high temperature exposures within CO₂ rich environments. In addition, samples obtained significant cohesive strength and could be further machined (cut or drilled) without falling apart.

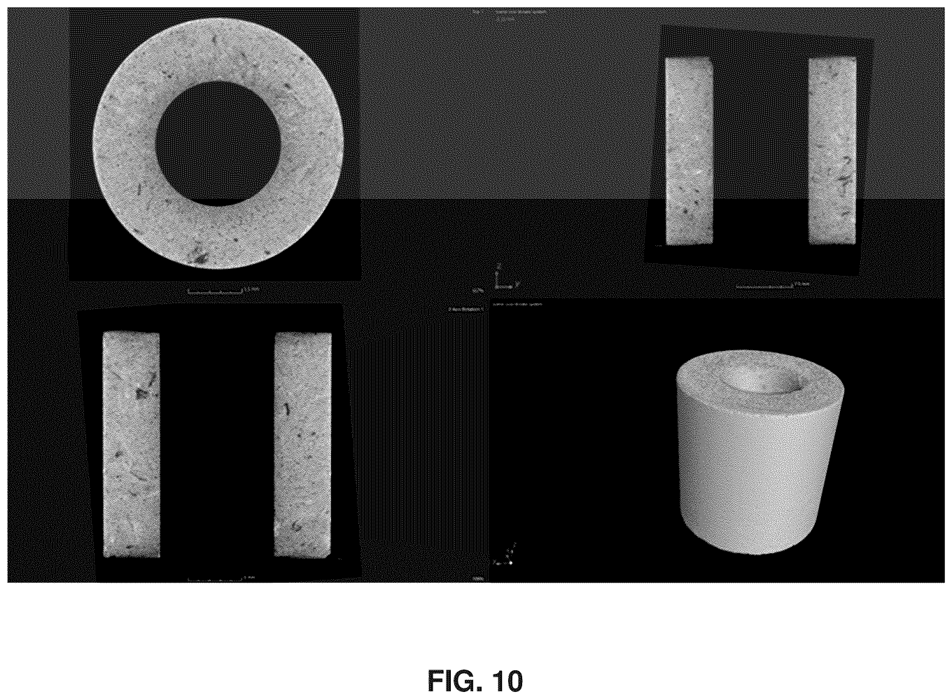

To investigate the cohesive nature of the calcinated samples fabricated, samples were analyzed by MicroCT tomography as exemplified in FIG. 10. As observed in the figure, uniform constancy and overall compactness was observed. No internal voids or stress cracks were present. Some of the larger low-density material observed (darker areas) was due to the BF formulation.

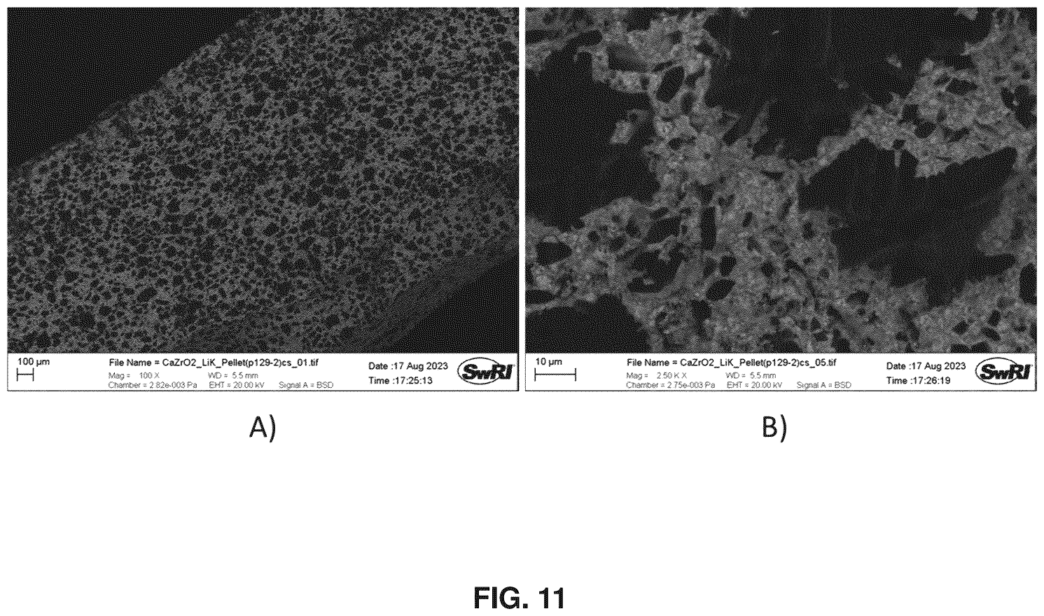

To investigate the morphology of the formulations, a sample of calcinated ZrO₂/carb material was cut and the cut surface was evaluated by environmental scanning electron microscopy (FIG. 11) to reveal the internal morphology of the product. As can be observed, the sample had an excellent overall packing/density of material with an interpenetrating network of zirconium rich areas (bright areas on the image) and homogeneously distributed zones of 10⁻¹⁰⁰ nm in size of zirconium deficient areas. This dense packing can encourage exclusion of gasses unintended for transport and the interpenetrating nature of the Zr rich phase can allow the active transport of CO₂ into and across the material.

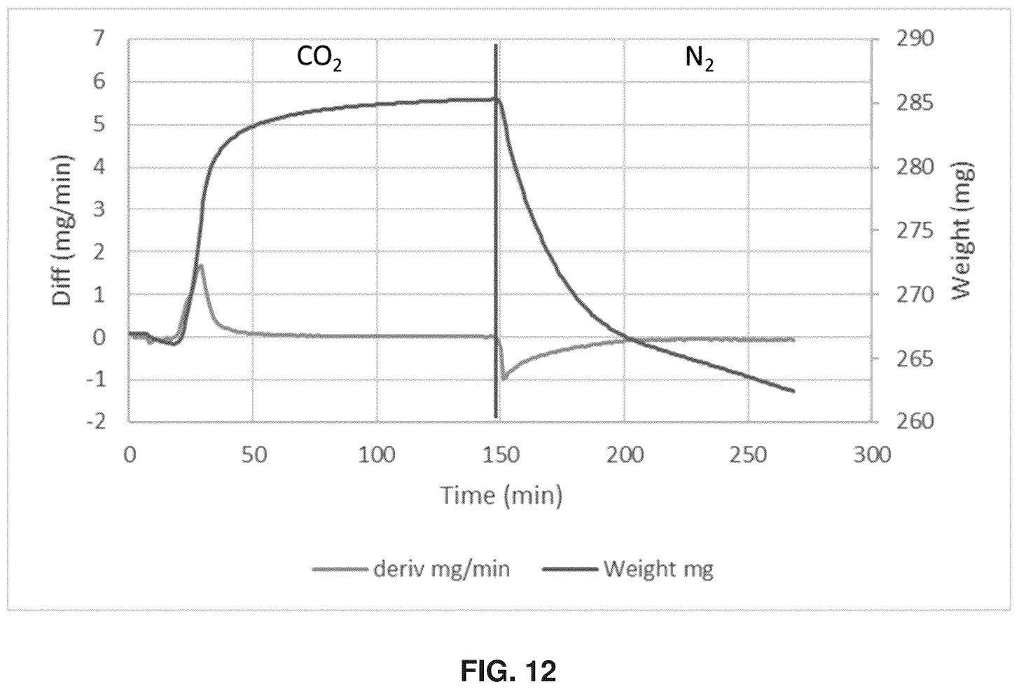

The activity of calcinated ZrO₂/carb+BF material was evaluated by thermal gravimetric analysis (TGA). The TGA plot shown in FIG. 12, provided as an example, is of a calcinated ZrO₂/carb+BF puck fabricated by compression molding. The thermal profile of the run included a thermal ramp of 20° C./min to 600° C. followed by an isotherm at 600° C. for 4 h. During the ramp and first two hours of the isotherm, the sample is purged with CO₂ to measure the absorption of CO₂ by the increase in weight of the sample. During the last two hours of the isotherm, the purge gas is switched to nitrogen to measure the rate of desorption of CO₂ in the form of weight loss during this time.

As can be observed from FIG. 12, the sample at 600° C. both absorbed CO₂ when exposed to CO₂ gas and then desorbed CO₂ when in a nitrogen atmosphere. This can be repeated multiple times. This behavior and profile is similar to what is observed for LZO powder (unshaped), thus indicating that the process for fabricating the formed shape did not adversely affect the performance of the sample.

### Example 5: LZO+Ceramic Binder

Commercially obtained LZO powder was combined with a ceramic binder containing alumina oxide (Al₂O₃) as the main filler material. The binder was added to the LZO powder at a ratio of 5:1 by weight (LZO) and thoroughly mixed to form a paste-like consistency.

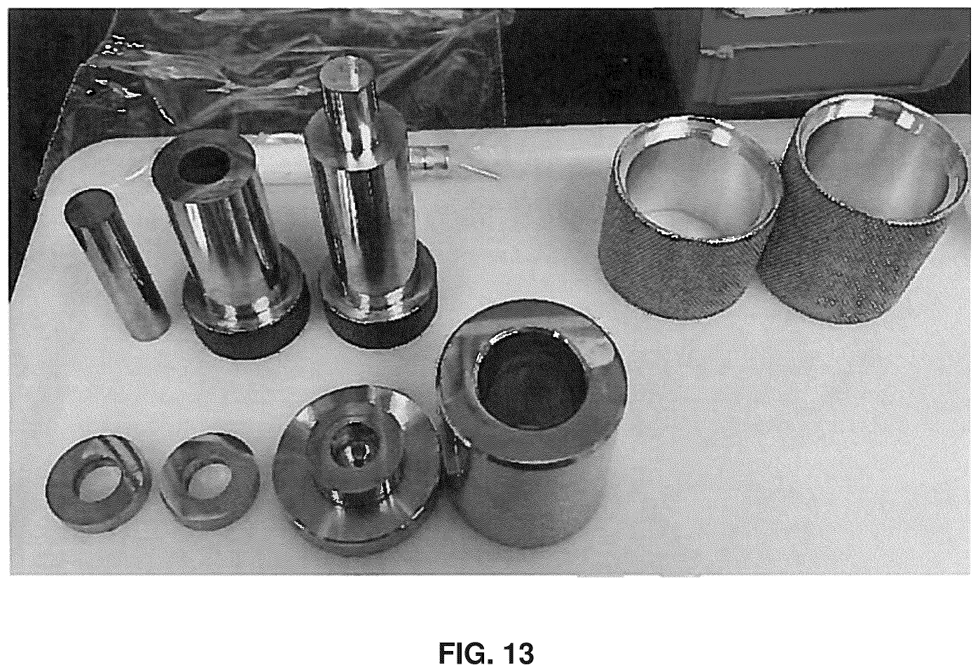

The mixture was then placed in ring forming compaction die, shown in FIG. 13. Once filled and assembled, the die assembly was placed in a press and a pressure of 15,000 psi was applied.

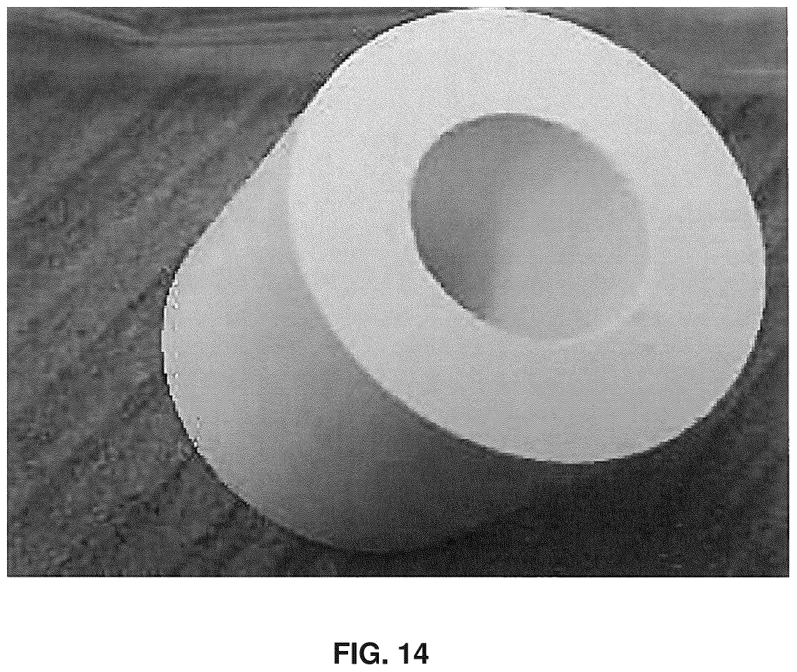

The press formed piece was removed from the die and placed in a furnace for heat treatment. The solid piece was heat treated to 800° C. in a programmable oven under an atmosphere of air. The oven was set with a ramp rate of 10° C./min and held at final temperature for 2.0 hours. The material was allowed to cool in the oven. The piece was then removed from the oven for examination, as shown in FIG. 14.

Micro CT analysis was performed to examine the internal structure of the solid piece. The internal structure of the test piece was absent of noticeable voids and fractures.

Thermal gravimetric analysis (TGA) was performed to determine if the binder formulated LZO remained CO₂ active. The following parameters and purge gases were used for the TGA analysis:
1. Ramp to 900° C. at 20° C./min| CO₂
2. Equilibrate to 25° C.| CO₂
3. Ramp to 600° C. at 20° C./min| CO₂
4. Isotherm for 2 h| CO₂
5. Isotherm for 2 h| N₂
(Repeat steps 3-5 for elevated temperatures)

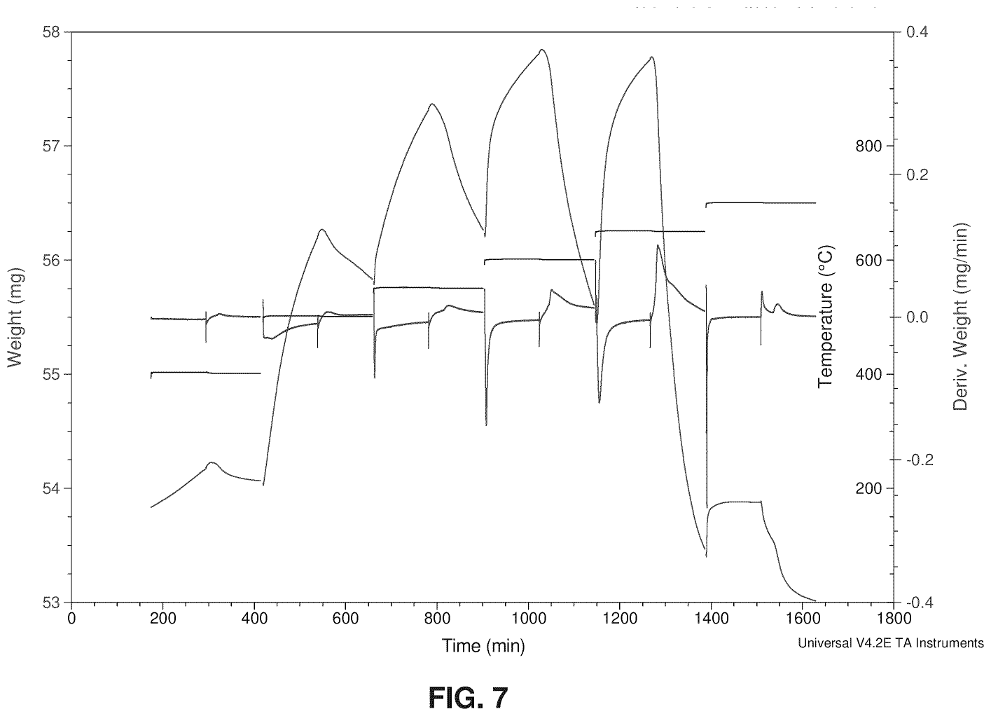

As an example, FIG. 7 shows an exemplary TGA plot of sol-gel LZO. Using these parameters, the absorption and desorption rate constants were calculated and are presented in Tables 3-4. These rate constants were determined for the ceramic binder formulated LZO and compared with other formulations.

TABLE 3
Absorption Rate (Ka) Comparison of LZO formulations with ceramic binders.

| Temp | | Temp | | Temp | | Temp | LZO/OM- |
|---|---|---|---|---|---|---|---|
| ° C. | LZO Aldrich | ° C. | ZrO₂/Carb | ° C. | ZrO₂/carb-BF | ° C. | POSS TEOS |
| 400 | 6.42574E−05 | 400 | 0.000909297 | 600 | 0.052632775 | 600 | 0.014942679 |
| 500 | 0.000174932 | 500 | 0.004622458 | 625 | 0.131363214 | 625 | 0.087030988 |
| 550 | 0.001119526 | 550 | 0.024487442 | 650 | 0.128239622 | 650 | 0.085312518 |
| 600 | 0.006703395 | 600 | 0.062887625 | 675 | 0.077409924 | 675 | 0.02466843 |
| 650 | 0.020651993 | 650 | 0.086300378 | 700 | 0.05708045 | 700 | 0.005011134 |
| 700 | 0.000987056 | 700 | 0.042531505 | | | | |

TABLE 4
Desorption Rate (Kd) Comparison of LZO formulations with ceramic binders.

| Temp | | Temp | | Temp | | Temp | LZO/OM- |
|---|---|---|---|---|---|---|---|
| ° C. | LZO Aldrich | ° C. | ZrO₂/Carb | ° C. | ZrO₂/carb-BF | ° C. | POSS TEOS |
| 400 | −0.001158889 | 400 | −0.000538006 | 600 | −0.022884615 | 600 | −0.012745211 |
| 500 | −0.002732407 | 500 | −0.000584 | 625 | −0.043110599 | 625 | −0.022158895 |
| 550 | −0.007434211 | 550 | −0.005456722 | 650 | −0.058697789 | 650 | −0.036511628 |
| 600 | −0.014460501 | 600 | −0.022809917 | 675 | −0.156877323 | 675 | −0.075410334 |
| 650 | −0.046333907 | 650 | −0.083475936 | 700 | −0.093681319 | 700 | −0.031352941 |
| 700 | −0.023515385 | 700 | −0.237942387 | | | | |

The analysis showed that the LZO+Ceramic Binder material maintained its CO₂ absorption and desorption capabilities, with enhanced absorption rate constants compared to unmodified LZO. A noticeable enhancement was observed for the absorption rate constant for all prepared formulations compared to the commercial material.

### Example 6: Comparative Analysis of Rate Constants for LZO Formulations

The calculated rate constants, measured from the TGA data, for the commercial (Sigma-Aldrich®) LZO and synthesized base formulations are tabulated in Tables 5-6. From this data, enhanced absorption rate constants were observed for all prepared formulations compared to the commercial material, whereas desorption rate constants are relatively similar up until 650° C.

TABLE 5
Absorption rate constants for LZO materials.

| Ka (1/min) | LZO | LZO | ZrO₂/ | LZO/OM- |
|---|---|---|---|---|
| Temp. (° C.) | Aldrich | (sol gel) | carb-BF | POSS TEOS |
| 600 | 6.70E−03 | 1.89E−02 | 5.26E−02 | 1.49E−02 |
| 625 | | 2.24E−02 | 1.31E−01 | 8.70E−02 |
| 650 | 2.07E−02 | 3.59E−02 | 1.28E−01 | 8.53E−02 |
| 675 | | 4.61E−02 | 7.74E−02 | 2.47E−02 |
| 700 | 9.87E−04 | 3.27E−02 | 5.71E−02 | 5.01E−03 |

TABLE 6
Desorption rate constants for LZO materials.

| Kd (1/min) | LZO | LZO | ZrO₂/ | LZO/OM- |
|---|---|---|---|---|
| Temp. (° C.) | Aldrich | (sol gel) | carb-BF | POSS TEOS |
| 600 | −1.45E−02 | −8.24E−03 | −2.29E−02 | −1.27E−02 |
| 625 | | −2.21E−02 | −4.31E−02 | −2.22E−02 |
| 650 | −4.63E−02 | −5.89E−02 | −5.87E−02 | −3.65E−02 |
| 675 | | −1.12E−01 | −1.57E−01 | −7.54E−02 |
| 700 | −2.35E−02 | −1.32E−01 | −9.37E−02 | −3.14E−02 |

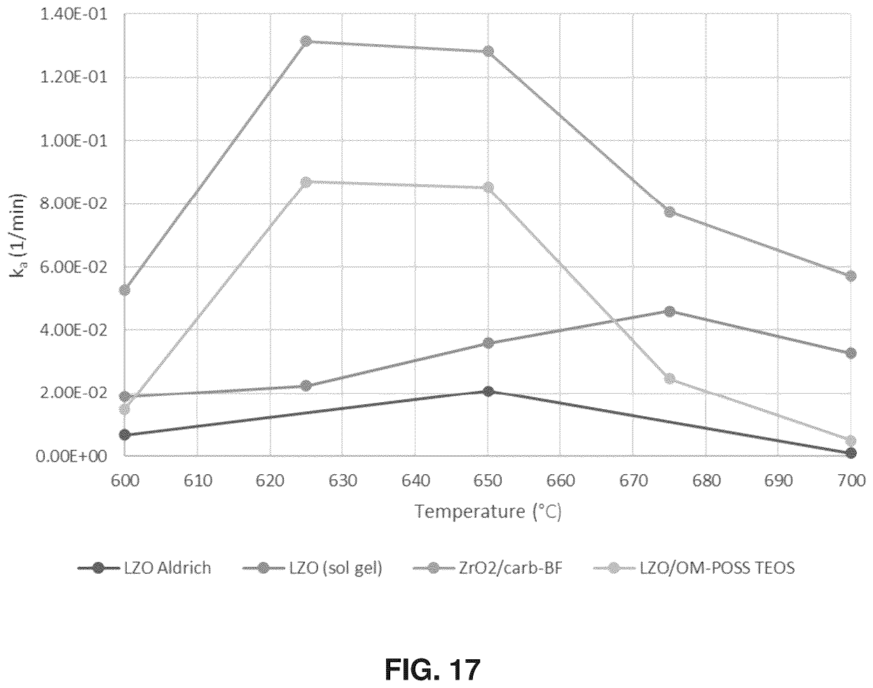

FIG. 17 shows a graphical representation of the absorption rate constants (Ka) versus temperature for the various LZO formulations, including LZO Aldrich (commercial material), LZO (sol-gel), ZrO₂/carb-BF, and LZO/OM-POSS TEOS. The plot clearly demonstrates that the ZrO₂/carb-BF formulation exhibits superior CO₂ absorption kinetics, particularly in the temperature range of 625-650° C., where it reaches a maximum Ka value of approximately 0.13 min⁻¹, which is nearly an order of magnitude higher than the commercial LZO material. The LZO/OM-POSS TEOS formulation also shows significantly enhanced performance compared to the commercial LZO, with peak absorption rates observed at similar temperatures.

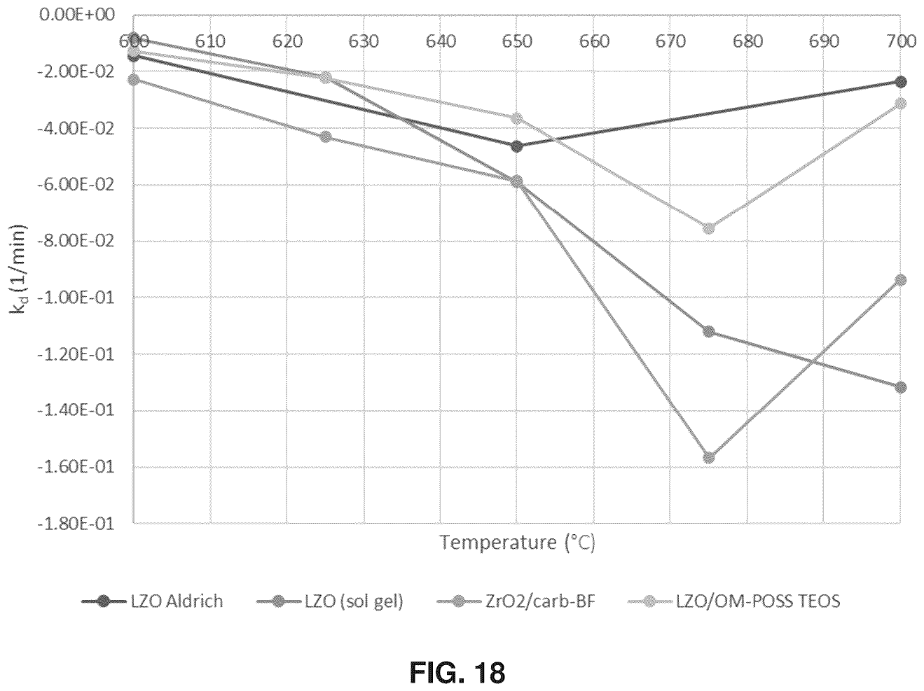

FIG. 18 presents the corresponding desorption rate constants (Kd) for the same formulations. As temperature increases, all formulations show increased desorption rates (more negative Kd values), with the ZrO₂/carb-BF formulation demonstrating the most rapid desorption at 675° C., indicating its potential for efficient CO₂ release during regeneration cycles. The LZO (sol-gel) formulation shows similarly enhanced desorption at 700° C., while the LZO/OM-POSS TEOS formulation exhibits more moderate desorption rates, which may be advantageous for applications requiring more controlled CO₂ release.

### Example 7: Rate Constants for Copper Infused Formulations and Formulations in Air

The calculated rate constants, measured from the TGA data, for synthesized sol-gel formulations were compared with a sol-gel formulation prepared with copper additive, as shown in Tables 7-8. Also included are the same formulations run in air, instead of nitrogen, purge during the desorption isotherms on the TGA. It is interesting to note that this change in purge gas, nor change in copper amount, did not appear to appreciably affect the desorption rate constants. However, a noticeable enhancement was observed for the absorption rate constants for samples that were exposed to air during the desorption and those that had copper. This may support the premise that copper and oxygen may improve the performance of the LZO in a similar way.

TABLE 7
Absorption rate constants for LZO formulations run
under nitrogen during the desorption isotherm or
run under air during the desorption isotherm.

| Ka (1/min) | LZO | LZO (sol | 0.01 | 0.01 |
|---|---|---|---|---|
| Temp. (° C.) | (sol gel) | gel) air | Cu-LZO | Cu-LZO air |
| 600 | 1.89E−02 | 2.30E−02 | 2.40E−02 | 2.86E−02 |
| 625 | 2.24E−02 | 3.43E−02 | 4.02E−02 | 5.85E−02 |
| 650 | 3.59E−02 | 6.21E−02 | 6.91E−02 | 7.99E−02 |
| 675 | 4.61E−02 | 5.62E−02 | 7.72E−02 | 8.34E−02 |
| 700 | 3.27E−02 | 3.55E−02 | 8.25E−02 | 7.93E−02 |

TABLE 8
Desorption rate constants for LZO formulations run
under nitrogen during the desorption isotherm or
run under air during the desorption isotherm.

| Kd (1/min) | LZO | LZO (sol | 0.01 | 0.01 |
|---|---|---|---|---|
| Temp. (° C.) | (sol gel) | gel) air | Cu-LZO | Cu-LZO air |
| 600 | −8.24E−03 | −1.07E−02 | −1.79E−02 | −2.24E−02 |
| 625 | −2.21E−02 | −2.76E−02 | −3.11E−02 | −3.95E−02 |
| 650 | −5.89E−02 | −6.42E−02 | −4.98E−02 | −6.13E−02 |
| 675 | −1.12E−01 | −1.05E−01 | −8.51E−02 | −8.19E−02 |
| 700 | −1.32E−01 | −1.08E−01 | −9.93E−02 | −1.22E−01 |

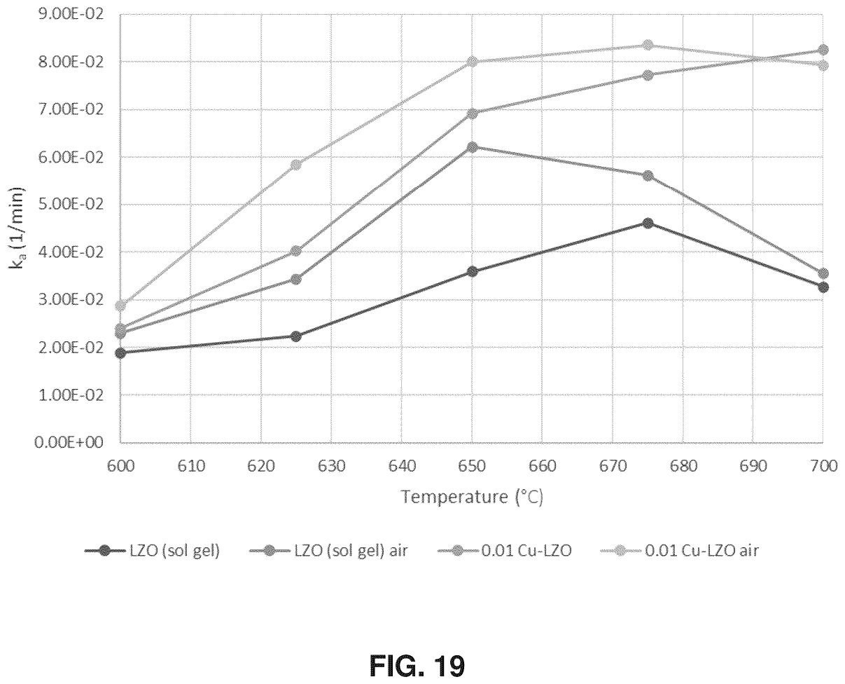

FIG. 19 shows the absorption rate constants (Ka) plotted against temperature for the LZO (sol-gel), LZO (sol-gel) air, 0.01 Cu-LZO, and 0.01 Cu-LZO air formulations. As can be observed, both the copper-infused formulation and the formulation tested with air during desorption exhibit significantly enhanced CO₂ absorption kinetics compared to the standard LZO (sol-gel) formulation. The 0.01 Cu-LZO air formulation demonstrates the highest performance across most temperatures, with absorption rates approaching 0.08 min⁻¹ at 650-675° C. This suggests a synergistic effect between copper addition and oxygen exposure that markedly improves the CO₂ capture capabilities of LZO-based compositions.

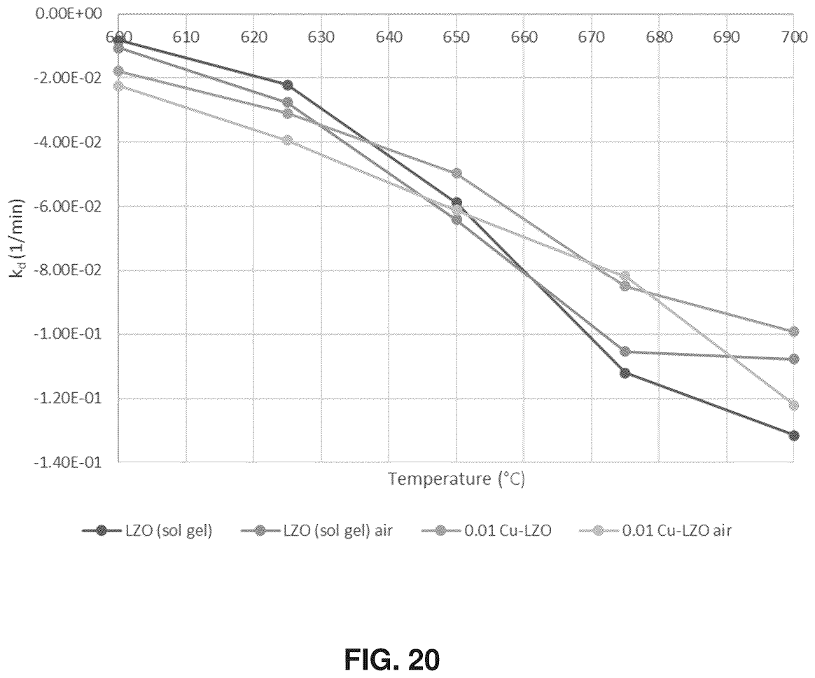

FIG. 20 presents the corresponding desorption rate constants (Kd) for these formulations. The desorption profiles are relatively similar across all formulations, with the most rapid desorption observed at 675-700° C. The LZO (sol-gel) formulation shows slightly higher desorption rates at 700° C. compared to the copper-infused formulations, but the differences are less pronounced than in the absorption rate constants. This indicates that while copper and air exposure significantly enhance CO₂ uptake kinetics, they have less impact on the release kinetics, which may be beneficial for controlled CO₂ capture and release cycles in practical applications.

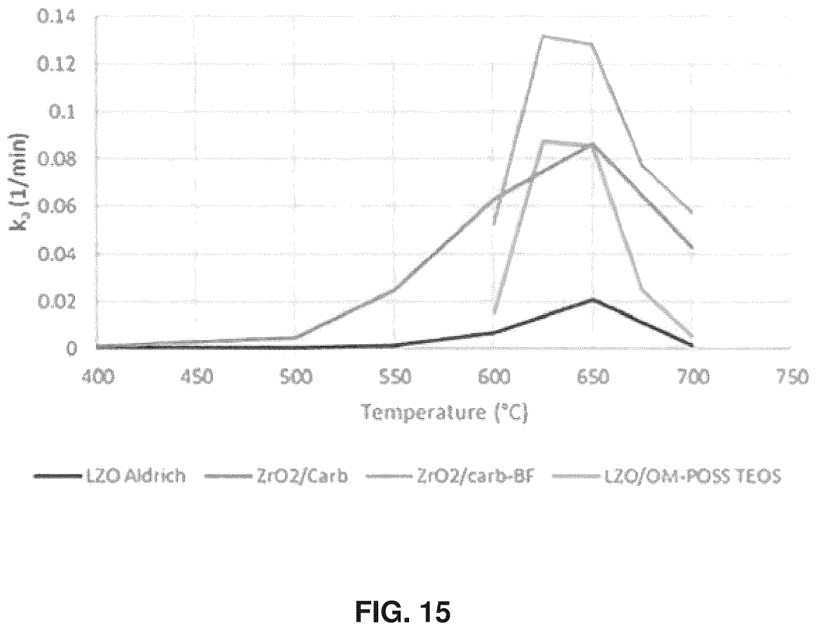

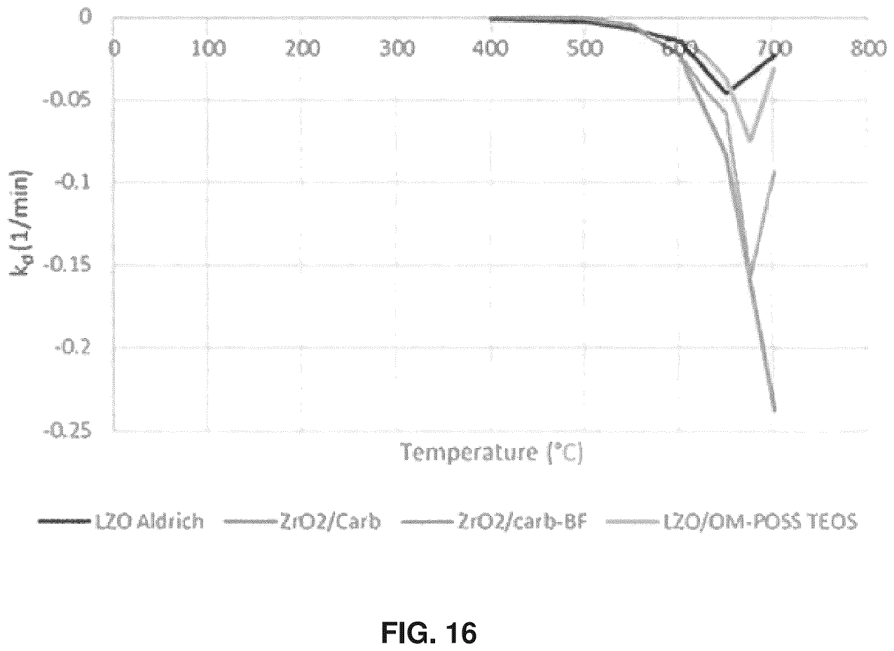

Tables 3-8 and FIGS. 15-20 collectively demonstrate the enhanced performance of the various LZO formulations described in this disclosure compared to conventional LZO materials. In particular, the ZrO₂/carb-BF formulation and the copper-infused LZO formulations show significantly improved absorption rate constants across multiple temperatures, while maintaining appropriate desorption characteristics.

Taken together, the examples demonstrate successful applications of three complementary approaches to creating robust lithium zirconate-based compositions for CO₂ separation. LZO/POSS micro-aggregates, ZrO₂/carbonate+BF formulations, and ceramic binder compositions all overcome the inherent fragility of conventional LZO materials while significantly enhancing CO₂ absorption kinetics. The comparative analyses quantitatively establish that ZrO₂/carb-BF formulations show nearly an order of magnitude improvement in absorption rates, while copper additives and air exposure further enhance performance. These advances enable practical implementation of LZO-based compositions in industrial CO₂ capture processes where both mechanical durability and efficient separation capabilities are required.

What is claimed is:

1. A composition for carbon dioxide separation comprising lithium zirconate and a binder material, wherein the composition forms a solid body capable of selectively separating carbon dioxide from gas mixtures at high temperatures.

2. The composition of claim 1, wherein the lithium zirconate is prepared by reacting lithium carbonate with zirconium oxide.

3. The composition of claim 1, wherein the binder material comprises at least one ceramic filler material.

4. The composition of claim 3, wherein the binder material comprises at least one component selected from the group consisting of aluminum oxide (Al₂O₃), aluminum nitride (AlN), aluminum oxide-quartz (Al₂O₃—SiO₂), magnesium oxide (MgO), silicon dioxide (SiO₂), zirconium oxide-zirconium ortho silicate (ZrO₂—ZrSiO₄), zirconium oxide (ZrO₂), and silicon carbide (SiC).

5. The composition of claim 1, wherein the lithium zirconate has a chemical formula of Li₍₂₊ₓ₎Zr_{(1-z)} O₃, wherein 0≤x≤0.5 and 0.01≤z≤0.1.

6. The composition of claim 1, further comprising potassium to form a eutectic composition which has a chemical formula of Li₍₂₊ₓ₎K_{y}Zr₍₁₋₂₎ O₃, wherein 0≤x≤0.5 and 0.15≤y≤0.25 and 0.01≤z≤0.1.

7. The composition of claim 1, wherein the solid body has a carbon dioxide absorption rate constant that is at least 2 times higher than that of pure lithium zirconate at a temperature between 600° C. and 700° C.

8. The composition of claim 1, further comprising a polyhedral oligomeric silsesquioxane (POSS) component forming a micro-aggregate structure with the lithium zirconate.

9. The composition of claim 8, wherein the POSS component comprises octamethyl-POSS or octaphenyl-POSS.

10. The composition of claim 8, wherein the lithium zirconate and POSS are combined at a weight ratio of 1.5:1 to 12:1.

11. The composition of claim 8, further comprising a chemical additive selected from the group consisting of tetraethoxysilane (TEOS), colloidal silica, and ethanol.

12. A solid-state lithium zirconate composition for carbon dioxide separation from a gas mixture, the composition comprising: a solid body formed from lithium zirconate and a ceramic binder material or a lithium zirconate-POSS micro-aggregate; wherein the composition exhibits a carbon dioxide absorption rate constant greater than 0.05 min⁻¹ at a temperature between 600° C. and 700° C.; and wherein the composition maintains structural integrity during carbon dioxide absorption and desorption cycles.

13. The composition of claim 12, wherein the lithium zirconate comprises potassium-modified lithium zirconate having a molar ratio of lithium to potassium to zirconium of 2.0 to 2.5:0.15 to 0.25:0.9 to 0.99.

14. The composition of claim 12, wherein the composition is configured to withstand volumetric dimensional changes during carbon dioxide sorption and thermal cycling without substantial mechanical degradation.

15. A composition for separating carbon dioxide gas, comprising: a lithium zirconate and a polyhedral oligomeric silsesquioxane (POSS), wherein the POSS is present in a weight ratio between 0.07 and 1 to the lithium zirconate, wherein the POSS is octamethyl silsesquioxane or octaphenyl silsesquioxane.

16. The composition of claim 15, wherein the octamethyl silsesquioxane is present in a weight ratio between 0.125 and 0.25 to the lithium zirconate, or wherein the octaphenyl silsesquioxane is present in a weight ratio between 0.33 and 1 to the lithium zirconate.

17. A composition for separating carbon dioxide gas, the composition comprising: zirconium oxide, lithium carbonate, potassium carbonate, and a binder, wherein: the lithium carbonate is present in a molar ratio between 2 and 3 to the zirconium oxide, the potassium carbonate is present in a molar ratio between 0.1 and 1 to the zirconium oxide, and the binder is present in a weight ratio between 1 and 50% to the zirconium oxide.

18. A composition for separating carbon dioxide gas, the composition comprising: lithium zirconate, potassium carbonate, and a binder, wherein: the potassium carbonate is present in a molar ratio between 0.1 and 1 to the lithium zirconate, and the binder is present in a weight ratio between 1 and 50% to the lithium zirconate, wherein the binder comprises Bisque Fix and sodium silicate.

19. The composition of claim 17 or 18, wherein a carbon dioxide absorption rate constant of the composition is between 5.00×10⁻² min⁻¹ and 6.00×10⁻² min⁻¹ at 600° C. or between 5.00×10⁻² min⁻¹ and 6.00×10⁻² min⁻¹ at 700° C.

20. The composition of claim 17 or 18, wherein a carbon dioxide desorption rate constant of the composition is between −2.00×10⁻² min⁻¹ and −3.00×10⁻² min⁻¹ at 600° C. or between −9.00×10⁻² min⁻¹ and −10.00×10⁻² min⁻¹ at 700° C.

21. A method of manufacturing a lithium zirconate-based micro-aggregate composition, the method comprising: combining lithium zirconate powder with a polyhedral oligomeric silsesquioxane (POSS) component; adding a thermally decomposable liquid binder to form a moldable mixture; forming the mixture into a desired shape; and sintering the formed mixture at a temperature between 600° C. and 900° C. to create a solid micro-aggregate composition.

22. The method of claim 21, wherein the POSS component comprises octamethyl-POSS or octaphenyl-POSS.

23. The method of claim 21, wherein the liquid binder comprises tetraethoxysilane (TEOS) or colloidal silica.

24. The method of claim 21, wherein forming the mixture into a desired shape comprises compression molding, pressing, or slip casting.

25. The method of claim 21, further comprising compressing the formed mixture at a pressure ranging from 5,000 psi to 20,000 psi.

26. The method of claim 21, wherein the micro-aggregate composition exhibits enhanced mechanical strength, fracture toughness, and dimensional stability during carbon dioxide sorption and thermal cycling compared to pure lithium zirconate composition.

27. A method of separating carbon dioxide from a gas mixture, the method comprising: contacting the gas mixture with a solid-state composition comprising lithium zirconate and a ceramic binder material or a lithium zirconate-POSS micro-aggregate at a temperature between 600° C. and 700° C.; wherein the lithium zirconate reacts with carbon dioxide in the gas mixture to form lithium carbonate and zirconium oxide; and wherein the solid-state composition maintains structural integrity during carbon dioxide absorption and desorption cycles.

28. The method of claim 27, further comprising regenerating the solid-state composition by heating to a temperature sufficient to release the absorbed carbon dioxide.

29. The method of claim 27, wherein the solid-state composition comprises a potassium-modified lithium zirconate that has an enhanced range of carbon dioxide absorption at lower temperatures compared to unmodified lithium zirconate.

30. The method of claim 27, wherein the composition comprises a dense, cohered structure with enhanced mechanical properties that inhibits dimensional changes during carbon dioxide sorption and thermal cycling.

31. The method of claim 27, wherein copper is incorporated into the solid-state composition to enhance carbon dioxide absorption.

32. A method of forming a lithium zirconate composition for separating carbon dioxide gas comprising: mixing a lithium zirconate and a polyhedral oligomeric silsesquioxane (POSS) at a ratio between 1 and 10 to form a homogeneous mixture; optionally adding a tetraethoxysilane in a weight ratio between 1 and 3 or a colloidal silica in a weight ratio between 1 and 6; pressing the homogeneous mixture at a first pressure between 44 MPa and 92 MPa; and drying the homogeneous mixture at a first temperature between 201° C. and 350° C. with a heating ramp rate of 1-5° C. per minute for at least two hours at less than a second pressure of 0.07 MPa to form the lithium zirconate composition.

33. The method of claim 32, further comprising sintering the lithium zirconate composition at a second temperature between 601° C. and 900° C. with a heating ramp rate of 5-10° C. per minute for two hours.

34. The method of claim 32, wherein the POSS is octamethyl silsesquioxane or octaphenyl silsesquioxane, and wherein the carbon dioxide absorption rate constant of the lithium zirconate composition is between 1.00×10⁻² min⁻¹ and 2.00×10⁻² min⁻¹ at 600° C. or between 4.50×10⁻³ min⁻¹ and 5.50×10⁻³ min⁻¹ at 700° C.

35. A method of separating carbon dioxide gas, comprising: flowing an effluent gas mixture through a composition, wherein the composition comprises components selected from the group consisting of: (a) a lithium zirconate and a polyhedral oligomeric silsesquioxane (POSS), wherein the POSS is present in a weight ratio between 0.07 and 1 to the lithium zirconate; and (b) a lithium zirconate, potassium (K), and a binder, wherein the potassium (K) is present in a molar ratio between 0.1 and 1 to the lithium zirconate, and the binder is present in a weight ratio between 1 and 50% to the lithium zirconate; absorbing the carbon dioxide gas into the composition at a temperature between 450° C. and 650° C., wherein the composition absorbs the carbon dioxide at an absorption rate constant between 1.00×10⁻² min⁻¹ and 1.00×10⁻¹ min⁻¹; and desorbing the carbon dioxide gas from the composition at a temperature above 651° C., wherein the composition desorbs the carbon dioxide at a desorption rate constant between −8.00×10⁻² min⁻¹ and −2.50×10⁻² min⁻¹.

36. The method of claim 35, wherein the POSS is octamethyl silsesquioxane or octaphenyl silsesquioxane.
